(19) United States
(12) Patent Application Publication
(10) Pub. No.: US 2006/0069754 A1
(43) Pub. Date: Mar. 30, 2006

(54) Enablement of software-controlled services required by installed applications

(76) Inventors: Keith Buck, Fort Collins, CO (US); Tyler Easterling, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/882,943

(22) Filed: Jun. 30, 2004

(51) Int. Cl. G06F 15/177

(52) U.S. Cl. 709/220

(57) ABSTRACT

Sequences of instructions may be stored on machine-readable media such that, when they are executed by a machine, the instructions cause the machine to 1) identify a number of applications installed on the machine, 2) identify a number of software-controlled services required by the installed applications, and 3) enable the software-controlled services required by the applications and ensure that non-required services are disabled. Related methods and apparatus are also disclosed.

### BACKGROUND

A basic principle of computer security is to run only those software-controlled services that are necessary, since each of the services is a possible attack vector. The processes used to disable unnecessary services are often referred to as “hardening” or “lockdown” processes.

In some cases, hardening is undertaken manually. However, manual hardening is labor intensive and error prone. In other cases, hardening is initiated via a hardening/configuration script. However, the usefulness of such scripts is generally limited to static environments, wherein the configuration of a machine, including its installed applications, remains relatively constant.

One way to tailor hardening to a particular machine is via hardening profiles. That is, if a machine may assume one of a number of different roles, a hardening profile may be created for each role. During hardening, a machine administrator may input the machine's role, and the hardening profile corresponding to the role can be accessed to initiate the hardening process. However, for a machine installed in a dynamic environment, the number of different configurations that the machine can assume grows exponentially with the number of applications that can possibly be installed on the machine. If the number of applications that can be installed on the machine is large, developing a hardening profile for each permutation of applications can become a difficult task.

### SUMMARY OF THE INVENTION

In one embodiment, sequences of instructions are stored on machine-readable media. When executed by a machine, the instructions cause the machine to 1) identify a number of applications installed on the machine, 2) identify a number of software-controlled services required by the installed applications, and 3) enable the software-controlled services required by the applications, and ensure that non-required services are disabled.

Other embodiments are also disclosed.

### BRIEF DESCRIPTION OF THE DRAWINGS

Illustrative and presently preferred embodiments of the invention are illustrated in the drawings, in which:

FIG. 1 illustrates a computer in an exemplary environment; and

FIG. 2 illustrates a method for enabling and disabling software-controlled services of the FIG. 1 computer.

### DETAILED DESCRIPTION OF AN EMBODIMENT

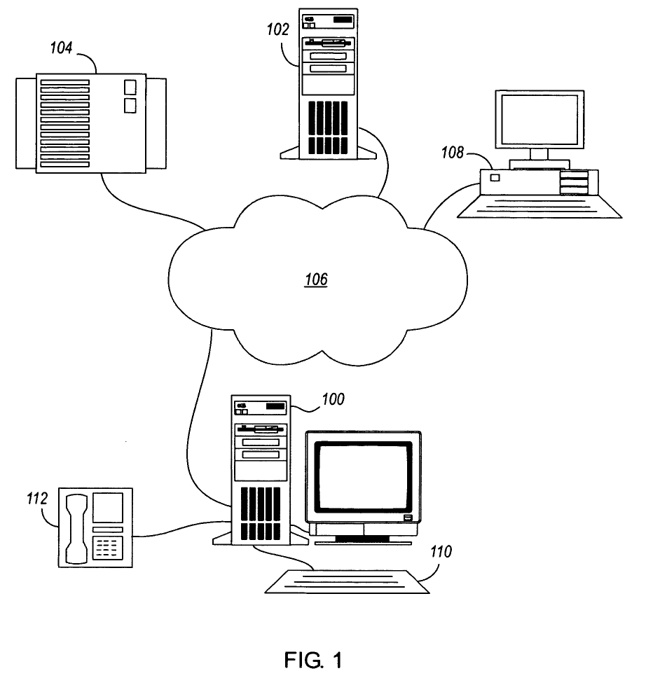

As a basis for describing the inventive concepts disclosed herein, an exemplary environment in which the inventive concepts may be employed will be described first. To this end, FIG. 1 illustrates a computer 100 that, by way of example, comprises or is connected to a plurality of memory, storage, communication and I/O devices. The memory may comprise, for example, random-access memory (RAM) or read-only memory (ROM) that is permanently or removably installed in the computer 100. The storage devices may comprise, for example, direct-attached removable or fixed drives that are booted with the computer, or remote devices to which the computer 100 is coupled, such as server-controlled storage 102, network-attached storage (NAS) 104, or a storage-area network (SAN). The communication devices may comprise, for example, communication ports, network cards, or modems. By means of a network card, the computer 100 may be coupled to a network 106 on which various additional storage, computing 108, communication and I/O devices may reside. The I/O devices may comprise, for example, a keyboard 110, a mouse, a personal digital assistant (PDA), or a telephone 112. In some embodiments, the computer 100 may comprise more or fewer of the above-mentioned devices.

The computer 100 may take various forms, including that of a personal computer, an application server, a web server, a file server, a server within a utility data center or computing grid, a switch, or a firewall.

Each of the devices connected to computer 100 represents a means of attack on the computer 100. That is, a means by which malicious code or instructions may be provided to the computer 100 to either 1) disrupt operation of the computer 100, 2) corrupt the data accessed by the computer 100, or 3) cause the computer 100 to disrupt the operation or data of other computers and devices.

One way in which the computer 100 may be attacked is by exploiting its software-controlled services (hereinafter referred to as “services”). Services may take various forms, including those of middleware applications, applets, scripts, COM objects, DCOM objects, or CORBA objects. One example of a service is a protocol translator to allow devices conversing in TCP/IP, Novell's SPX/IPX, Microsoft's NetBEUI/NetBIOS, and IBM's SNA to communicate with each other in their native protocol, with the service providing the translation. Another example of a service is a character set converter that allows, for example, an application communicating in EBCDIC to access a file in a database written in ASCII. Other examples of services include machine-specific services, RPC services, and mail services.

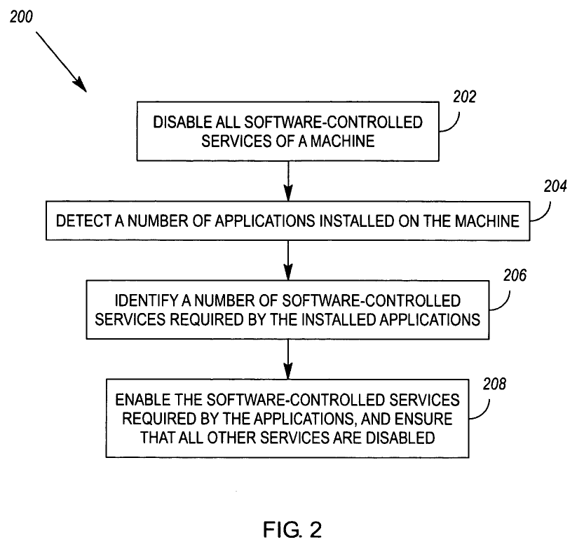

A machine's services can be exploited by exploiting holes in its services, as well as by launching and exploiting unnecessary services. FIG. 2 therefore illustrates a method 200 for enabling and disabling a computer's services.

The method 200 comprises detecting 204 a number of applications installed on a particular machine (e.g., the computer 100) and identifying 206 a number of software-controlled services that are required by the installed applications. The software-controlled services required by the installed applications are then enabled 208, and non-required services are disabled (or at least checked to ensure that they are disabled). In some cases, enabling services may comprise configuring the services.

The installed applications may be detected 204 in a variety of ways. In one embodiment, the installed applications may be detected by parsing an operating system file, such as an application registry file. In another embodiment, the installed applications may be detected by searching for files that are known to correspond to particular applications or application types (e.g., by searching for certain executable or configuration files).

When detecting installed applications, the method 200 may attempt to detect all installed applications, or some subset thereof. For example, detection of installed applications could be limited to “high level” applications (e.g., a web server, database application, word processor or spreadsheet application). Or, detection of installed applications could be limited to applications designed to fulfill a particular purpose or purposes. Detection of installed applications could also be limited to “most currently used”, “most frequently used” or even “currently running” applications.

The software-controlled services required by the detected applications may also be identified 206 in a variety of ways. For example, the required services may be identified by accessing lists of services that are required for each of a number of known applications. In one embodiment, such lists comprise atomic, idempotent actions that are to be executed when enabling the listed services. The required services may also be identified by accessing lists of services that are required for each of a number of application types, or by accessing one or more lists of services that are published by the identified applications. Required services could also be identified by logging network traffic.

Since many high-level services require the availability of other services, some of which are dependent on a machine's hardware, lists of dependent services may be maintained as part of the method 200. By way of example, the lists may be maintained as XML files, hard-coded algorithms. Also, the lists may need to be generated in response to analysis of a machine's available hardware.

In some cases, identifying the services required by detected applications may comprise determining that one or more services required by a detected application need not be enabled as a result of another application being installed on the machine on which the method 200 is executed. It may also be determined that one or more services required by a detected application need not be enabled as a result of the configuration of the machine on which the application is installed.

In one embodiment of the method 200, all software-controlled services that can be disabled are disabled 202 prior to detection of the installed applications. This embodiment differs from typical manual hardening processes, wherein all services are initially enabled, and then services are turned “off” until something breaks (e.g., an application ceases to function correctly). Rather, this embodiment of the method 200 begins with all services disabled, and then only turns “on” those services that installed applications require.

In another embodiment of the method 200, software-controlled services required by applications are marked as (or after) they are identified. Then, only those services that have been marked are enabled, and all unmarked services that can be disabled are disabled (or at least checked to ensure that they are disabled). In some cases, the method 200 may begin by attempting to disable all software-controlled services that have not already been marked for preservation. In this manner, repeated executions of the method 200 need not begin with the disablement of “all” services, but only those services that were not previously marked for preservation.

The method 200 may be launched (and preferably, automatically launched) at various times, including: upon application install, upon application uninstall, upon application reconfiguration, upon operating system reconfiguration, or upon boot of the machine. If a service configuration error is introduced by human error, a launch of method 200 can be used to re-analyze a machine and correct the error.

The method 200 may also be launched upon application launch or termination. In this manner, services may be enabled only when they are needed. In cases where more than one application is utilizing a service, the service may be terminated when all applications that require the service have terminated or otherwise indicated that they no longer need the service. As a further option, applications that are idle, such as when substantially no processor, memory access, storage access, or bus activity has been triggered by the application for a length of time, may have their required services terminated. As an implementation option, a true no-activity state may be required before the application's services are terminated. However, services may be terminated when substantially no activity is performed by the application, such as when an application is only counting clock cycles, repeatedly reading a memory value that remains unchanged, or taking other action that is indicative of the application being in a “wait” state. Terminated services may then be restarted when the application performs an action that signals the start of activity.

Given that the method 200 is intended to be executed by a machine (e.g., computer 100), the actions of the method may be embodied in sequences of instructions stored on machine-readable media (e.g., any one or more of a fixed disk, a removable disk such as a CD-ROM or DVD, or a memory device such as RAM or ROM). When executed, the instructions then cause the machine to perform the actions of the method 200. For example, when loaded onto the storage (i.e., media) of a computer system, the sequence of instructions may cause the method 200 to be executed as an automatic or user-launched utility that causes a processor of the computer system to execute the method 200.

In one embodiment, the sequences of instructions may define a user interface through which the method 200 (or actions thereof may be launched. In this manner, the method 200 (or actions thereof may be launched whenever a user deems execution of the method 200 (or actions thereof to be necessary.

In general, the method 200 helps to maximize security while enabling each installed application to function as expected.

Unlike many past hardening processes, the method 200 generally adapts the hardening process to the applications it detects, rather than to the machine on which it is executed. This application-centric approach provides for easier removal and redeployment of applications than previous hardening processes, in which hardening was largely based on a machine's configuration (i.e., machine type or role). An application-centric approach also enables the identification of required services to be broken into definable areas of responsibility. That is, the services required by each application can be identified with the assistance of an expert on the application, rather than having to rely on a system administrator (who may not be an expert on any particular application) for such details.

The method 200 also tends to be more modular than past hardening processes. That is, if an additional application is to be handled by the method 200, a list of its required services need only be retrieved or developed. There is no need to incorporate the application into one or more host-centric profiles or roles, as a machine's role is not statically specified, but rather dynamically inferred from the set of applications that are actually installed on the machine.

In the past, applications have typically been developed in a custom-security or even security-free environment. In such an environment, the application developer is typically free to make their application depend on any services they would like. When the application is then installed in an end-user's secure environment, it may take numerous iterations of security “adjustments” to get the application to function. Using the method 200, an application can be developed in the same adaptive security environment that an end-user might use, with the application developer adding each service on which the application depends to a published list that is accessible by software executing the method 200. If for some reason the “application in development” ceases to function, the cause of such failure can then be proactively addressed.

Not only can the method 200 migrate the enablement of services to an application-centric task, but the method 200 can also remove service enablement and configuration from the applications themselves. The enablement and configuration of services is thus performed by a separately manageable hardening process rather than by each individual application. Not only does this improve security (e.g., by not allowing possibly compromised applications to enable whatever services they want), but it also allows the processes for enabling and configuring services to be migrated to a stand-alone process that can re-use its technology for a variety of applications.

What is claimed is:

1. Machine-readable media having stored thereon sequences of instructions that, when executed by a machine, cause the machine to perform the actions of:
detecting a number of applications installed on said machine;
identifying a number of software-controlled services required by said installed applications; and
enabling said software-controlled services required by said applications, and ensuring that non-required services are disabled.

2. The machine-readable media of claim 1, wherein said installed applications are detected by searching for files that are known to correspond to particular applications.

3. The machine-readable media of claim 1, wherein said installed applications are detected by parsing an operating system file.

4. The machine-readable media of claim 3, wherein the parsed operating system file is an application registry file.

5. The machine-readable media of claim 1, wherein said software-controlled services required by said installed applications are identified, at least in part, by accessing lists of services required for each of a number of known applications.

6. The machine-readable media of claim 5, wherein said lists of services required for said known applications comprise atomic, idempotent actions that are to be executed when enabling said listed services.

7. The machine-readable media of claim 1, wherein said software-controlled services required by said installed applications are identified, at least in part, by accessing lists of services required for each of a number of application types.

8. The machine-readable media of claim 1, wherein said software-controlled services required by said installed applications are identified, at least in part, by accessing one or more lists of services published by said identified applications.

9. The machine-readable media of claim 1, wherein enabling said software-controlled services comprises configuring at least some of said services.

10. The machine-readable media of claim 1, wherein said actions further comprise marking said software-controlled services required by said installed applications, enabling only those services that are marked, and ensuring that all unmarked services that can be disabled are disabled.

11. The machine-readable media of claim 1, wherein said actions further comprise, prior to detection of said installed applications, attempting to disable all software-controlled services that have not been marked for preservation.

12. The machine-readable media of claim 1, wherein said actions further comprise, prior to detection of said installed applications, disabling all software-controlled services that can be disabled.

13. The machine-readable media of claim 1, wherein said actions further comprise launching said detecting, identifying, enabling and disabling actions upon application install.

14. The machine-readable media of claim 1, wherein said actions further comprise launching said detecting, identifying, enabling and disabling actions upon application uninstall.

15. The machine-readable media of claim 1, wherein said actions further comprise launching said detecting, identifying, enabling and disabling actions upon application reconfiguration.

16. The machine-readable media of claim 1, wherein said actions further comprise launching said detecting, identifying, enabling and disabling actions upon operating system reconfiguration.

17. The machine-readable media of claim 1, wherein said actions further comprise launching said detecting, identifying, enabling and disabling actions upon boot of the machine.

18. The machine-readable media of claim 1, wherein said actions further comprise providing a user interface through which said detecting, identifying, enabling and disabling actions are launched.

19. The machine-readable media of claim 1, wherein identifying a number of software-controlled services required by said installed applications comprises determining that one or more software-controlled services required by an installed application need not be enabled as a result of another application being installed on the machine.

20. The machine-readable media of claim 1, wherein said identification of a number of software-controlled services required by said installed applications comprises determining that one or more software-controlled services required by an installed application need not be enabled as a result of said machine's configuration.

21. The machine-readable media of claim 1, wherein a particular software-controlled service is enabled upon launch of a detected application that requires the particular software-controlled service, and wherein the particular software-controlled service is disabled when all detected applications that require the particular software-controlled service have been terminated.

22. The machine-readable media of claim 21, wherein the particular software-controlled service is also disabled when all detected applications that require the particular software-controlled service are in an idle state.

23. A method, comprising:
detecting a number of applications installed on a machine;
automatically identifying a number of software-controlled services required by said installed applications; and
automatically enabling said software-controlled services required by said applications and ensuring that non-required services are disabled.

24. The method of claim 23, wherein said installed applications are detected by searching for files that are known to correspond to particular applications.

25. The method of claim 23, wherein said software-controlled services required by said installed applications are identified, at least in part, by accessing lists of services required for each of a number of known applications.

26. The method of claim 25, wherein said lists of services required for said known applications comprise atomic, idempotent actions that are to be executed when enabling said listed services.

27. The method of claim 23, wherein said software-controlled services required by said installed applications are identified, at least in part, by accessing one or more lists of services published by said identified applications.

28. A computer system, comprising:
a processor;
storage; and
a utility, residing in said storage and executed by said processor, to i) detect a number of applications residing on said storage, ii) identify a number of software-controlled services required by said applications, and iii) enable the software-controlled services required by said applications and ensure that non-required services are disabled.

29. The computer system of claim 28, further comprising a display; wherein said utility provides a user interface for said display, said user interface providing for launch of said detecting, identifying, enabling and disabling actions.

30. The computer system of claim 28, wherein the utility enables a particular software-controlled service upon launch of a detected application that requires the particular software-controlled service, and wherein the utility disables the particular software-controlled service when all detected applications that require the particular software-controlled service have been terminated.
